(19) United States
(12) Patent Application Publication
(10) Pub. No.: US 2026/0056971 A1
(43) Pub. Date: Feb. 26, 2026

(54) SYSTEMS AND METHODS FOR DATA MIGRATION

(71) Applicant: Schlumberger Technology Corporation, Sugar Land, TX (US)

(72) Inventors: Raghavan Vuruputoor Krishnamachari, Pune (IN); Kunal Sharma, Pune (IN); Sandip Parkhi, Pune (IN)

(21) Appl. No.: 19/290,704

(22) Filed: Aug. 5, 2025

(30) Foreign Application Priority Data
Aug. 21, 2024 (IN) 202411063099

(51) Int. Cl. G06F 16/27

(52) U.S. Cl. CPC G06F 16/275

(57) ABSTRACT

Systems and methods for data migration are provided. A method for migrating bulk data from a first data platform to a second data platform includes: providing a virtual machine (VM) on a cloud service provider subscription, migrating access control list (ACL) information, one or more legal tags, and reference data from the first data platform to the second data platform, using the VM, analyzing data types of the bulk data, generating a file-generic data migration pipeline from the first data platform to the second data platform, using the VM, fetching storage records for the bulk data from the first data platform using the VM, migrating the bulk data from the first data platform to the second data platform, using the VM, validating the migrated bulk data in the second data platform, and synchronizing the migrated bulk data in the second data platform with changes made since the migrating began.

### CROSS-REFERENCE TO RELATED APPLICATION(S)

This application claims priority to and the benefit of Indian Provisional Patent Application No. 202411063099, filed on Aug. 21, 2024, the entire disclosure of which is incorporated herein by reference for all purposes.

### TECHNICAL FIELD

This disclosure generally relates to systems and methods for data migration.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

Operations in a reservoir, e.g., resource recovery, drilling, etc., require and generate large amounts of data that are typically stored in a data platform for access by various entities. Migrating the data from one data platform to another is typically a complicated, time-consuming, and expensive process.

Accordingly, there is a need for systems and methods for data migration.

### SUMMARY

This disclosure pertains to systems and methods for data migration.

A first aspect of this disclosure pertains to a method for migrating bulk data from a first data platform to a second data platform, the method including: providing a virtual machine (VM) on a cloud service provider subscription, migrating access control list (ACL) information, one or more legal tags, and reference data from the first data platform to the second data platform, using the VM to control the migrating, analyzing data types of the bulk data, generating a file-generic data migration pipeline from the first data platform to the second data platform, using the VM, fetching storage records for the bulk data from the first data platform using the VM, migrating the bulk data from the first data platform to the second data platform, using the VM to control the migrating, validating the migrated bulk data in the second data platform, and synchronizing the migrated bulk data in the second data platform with any changes made to the bulk data in the first data platform since the migrating the bulk data began.

A second aspect of this disclosure pertains to the method of the first aspect, wherein the migrating the access control list (ACL) information, one or more legal tags, and reference data from the first data platform to the second data platform includes: determining access to available ACL groups in the first data platform, creating new ACL groups in the second data platform, determining whether the one or more legal tags are different between the first data platform and the second data platform, in response to the one or more legal tags being determined to be different, mapping a change in the one or more legal tags determined to be different between the first data platform and the second data platform tags, adding the one or more legal tags to the second data platform, determining whether reference data is added or modified between the first data platform and the second data platform, and generating a query for determining which reference data is added or modified between the first data platform and the second data platform.

A third aspect of this disclosure pertains to the method of the second aspect, wherein the analyzing data types of the bulk data includes: generating a hierarchical data model of the data types to determine an order of ingestion of the bulk data, and determining a scope of ancestry migration based on the hierarchical data model.

A fourth aspect of this disclosure pertains to the method of the third aspect, wherein the generating the file-generic data migration pipeline includes: downloading files for a given set of record identifications (IDs) of the first data platform and ingesting the files into the second data platform, during the downloading and ingesting of the files, populating a migration database with ID mapping information about the record IDs and version information from the first data platform and the second data platform, and using the ID mapping information during migration of records from a storage service associated with the first data platform.

A fifth aspect of this disclosure pertains to the method of the fourth aspect, wherein the fetching the storage records for the bulk data includes: generating one or more schema for custom data types from the first data platform to the second data platform, running the file-generic data migration pipeline to migrate sample records corresponding to the custom one or more schema for the custom data types, determining an order of ingestion for the data types based on the hierarchical data model, selecting one data type at a time for ingestion, fetching the record IDs and iterating a list of sample Work Product Component (WPC) record IDs for the records from the storage service, transforming the records from a first data format compatible with the first data platform to a second data format compatible with the second data platform using the ACL groups, any changed legal tags, and record IDs, and ingesting the records.

A sixth aspect of this disclosure pertains to the method of the fifth aspect, wherein the transforming the records includes: changing each ACL based on a new tenant ID for each ACL, changing any of the one or more legal tags determined to be different, in response to a record ID including a version ID, removing the version ID from the record ID including the version ID, retaining ancestry records based on the determined scope of the ancestry migration, and providing a version ID for the ancestry records.

A seventh aspect of this disclosure pertains to the method of the sixth aspect, wherein the migrating the bulk data from the first data platform to the second data platform includes: iterating the list of sample WPC record IDs to fetch the bulk data associated with the list, ingesting the bulk data into the second data platform in an order based on the list, determining whether match and merge rules are used for a Well Known Entity (WKE) generation service in the first data platform, in response to determining that match and merge rules are used for the WKE generation service in the first data platform, checking and migrating the bulk data, analyzing mapping of Well-Known Schemas (WKS) associated with the bulk data, and changing a bulk data record ID of at least one associated WPC record using a mapping created at the time of creation of the bulk data.

An eighth aspect of this disclosure pertains to the method of the seventh aspect, wherein the validating the migrated bulk data in the second data platform includes: implementing search service application programming interfaces (APIs) to fetch record counts of all data types in both the first data platform and the second data platform, comparing the record counts of all data types in the first data platform to the record counts of all data types in the second data platform, comparing an attribute count, a name, and a value for a selected record in both the first data platform and the second data platform, and providing a visual validation of randomly selected migrated data in an application project pointing to the second data platform.

A ninth aspect of this disclosure pertains to the method of the eighth aspect, wherein the synchronizing the migrated bulk data includes: synchronizing the migrated bulk data in the second data platform with the bulk data in the first data platform for a predetermined period of time, and automatic retrieval of failures from a previous cycle.

A tenth aspect of this disclosure pertains to the method of the ninth aspect, wherein the fetching the storage records for the bulk data and the migrating the bulk data from the first data platform to the second data platform are performed in parallel.

An eleventh aspect of this disclosure pertains to a system for migrating bulk data from a first data platform to a second data platform, including: the first data platform, the second data platform, one or more processors, and at least one memory including at least one non-transitory computer-readable medium storing instructions that, when executed by at least one of the one or more processors, cause the system to perform operations, the operations including: providing a virtual machine (VM) on a cloud service provider subscription, migrating access control list (ACL) information, one or more legal tags, and reference data from the first data platform to the second data platform, using the VM to control the migrating, analyzing data types of the bulk data, generating a file-generic data migration pipeline from the first data platform to the second data platform, using the VM, fetching storage records for the bulk data from the first data platform using the VM, migrating the bulk data from the first data platform to the second data platform, using the VM to control the migrating, validating the migrated bulk data in the second data platform, and synchronizing the migrated bulk data in the second data platform with any changes made to the bulk data in the first data platform since the migrating the bulk data began.

A twelfth aspect of this disclosure pertains to the system of the eleventh aspect, wherein the migrating the access control list (ACL) information, one or more legal tags, and reference data from the first data platform to the second data platform includes: determining access to available ACL groups in the first data platform, creating new ACL groups in the second data platform, determining whether the one or more legal tags are different between the first data platform and the second data platform, in response to the one or more legal tags being determined to be different, mapping a change in the one or more legal tags determined to be different between the first data platform and the second data platform tags, adding the one or more legal tags to the second data platform, determining whether reference data is added or modified between the first data platform and the second data platform, and generating a query for determining which reference data is added or modified between the first data platform and the second data platform.

A thirteenth aspect of this disclosure pertains to the system of the twelfth aspect, wherein the analyzing data types of the bulk data includes: generating a hierarchical data model of the data types to determine an order of ingestion of the bulk data, and determining a scope of ancestry migration based on the hierarchical data model.

A fourteenth aspect of this disclosure pertains to the system of the thirteenth aspect, wherein the generating the file-generic data migration pipeline includes: downloading files for a given set of record identifications (IDs) of the first data platform and ingesting the files into the second data platform, during the downloading and ingesting of the files, populating a migration database with ID mapping information about the record IDs and version information from the first data platform and the second data platform, and using the ID mapping information during migration of records from a storage service associated with the first data platform.

A fifteenth aspect of this disclosure pertains to the system of the fourteenth aspect, wherein the fetching the storage records for the bulk data includes: generating one or more schema for custom data types from the first data platform to the second data platform, running the file-generic data migration pipeline to migrate sample records corresponding to the custom one or more schema for the custom data types, determining an order of ingestion for the data types based on the hierarchical data model, selecting one data type at a time for ingestion, fetching the record IDs and iterating a list of sample Work Product Component (WPC) record IDs for the records from the storage service, transforming the records from a first data format compatible with the first data platform to a second data format compatible with the second data platform using the ACL groups, any changed legal tags, and record IDs, and ingesting the records.

A sixteenth aspect of this disclosure pertains to the system of the fifteenth aspect, wherein the transforming the records includes: changing each ACL based on a new tenant ID for each ACL, changing any of the one or more legal tags determined to be different, in response to a record ID including a version ID, removing the version ID from the record ID including the version ID, retaining ancestry records based on the determined scope of the ancestry migration, and providing a version ID for the ancestry records.

A seventeenth aspect of this disclosure pertains to the system of the sixteenth aspect, wherein the migrating the bulk data from the first data platform to the second data platform includes: iterating the list of sample WPC record IDs to fetch the bulk data associated with the list, ingesting the bulk data into the second data platform in an order based on the list, determining whether match and merge rules are used for a Well Known Entity (WKE) generation service in the first data platform, in response to determining that match and merge rules are used for the WKE generation service in the first data platform, checking and migrating the bulk data, analyzing mapping of Well-Known Schemas (WKS) associated with the bulk data, and changing a bulk data record ID of at least one associated WPC record using a mapping created at the time of creation of the bulk data.

An eighteenth aspect of this disclosure pertains to the system of the seventeenth aspect, wherein the validating the migrated bulk data in the second data platform includes: implementing search service application programming interfaces (APIs) to fetch record counts of all data types in both the first data platform and the second data platform, comparing the record counts of all data types in the first data platform to the record counts of all data types in the second data platform, comparing an attribute count, a name, and a value for a selected record in both the first data platform and the second data platform, and providing a visual validation of randomly selected migrated data in an application project pointing to the second data platform.

A nineteenth aspect of this disclosure pertains to the system of the eighteenth aspect, wherein the synchronizing the migrated bulk data includes: synchronizing the migrated bulk data in the second data platform with the bulk data in the first data platform for a predetermined period of time, and automatic retrieval of failures from a previous cycle.

A twentieth aspect of this disclosure pertains to the system of the nineteenth aspect, wherein the fetching the storage records for the bulk data and the migrating the bulk data from the first data platform to the second data platform are performed in parallel.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIGS. 1A-1D are schematic views of an oilfield.

FIG. 2 is a schematic view of an example oilfield.

FIG. 3 is a schematic view of an example oilfield.

FIG. 4 is a schematic view of an example computing system.

FIG. 5 is a flowchart for an example workflow.

FIG. 6 is a schematic view of an example data architecture.

FIG. 7 is a schematic of an example solution architecture.

FIG. 8 is a schematic of an example data migration strategy.

FIG. 9 is flowchart for an example workflow.

FIG. 10 is a flowchart for an example extraction workflow.

FIG. 11 is a flowchart for an example transformation workflow.

FIG. 12 is a flowchart for an example loading/ingestion workflow.

FIG. 13 is an example method according to an example embodiment.

FIG. 14 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

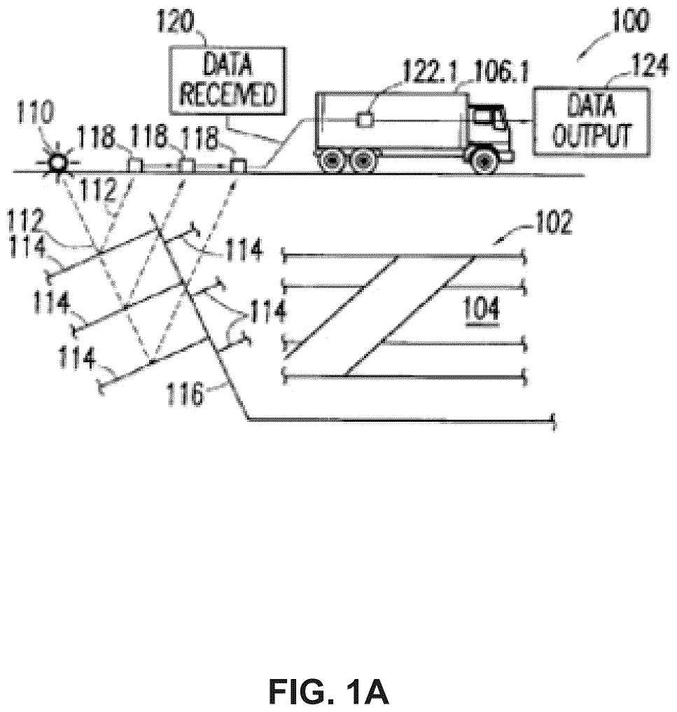

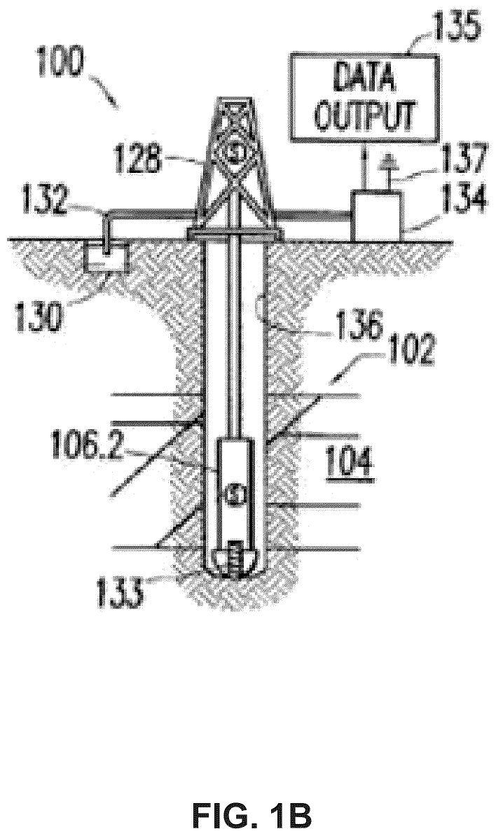

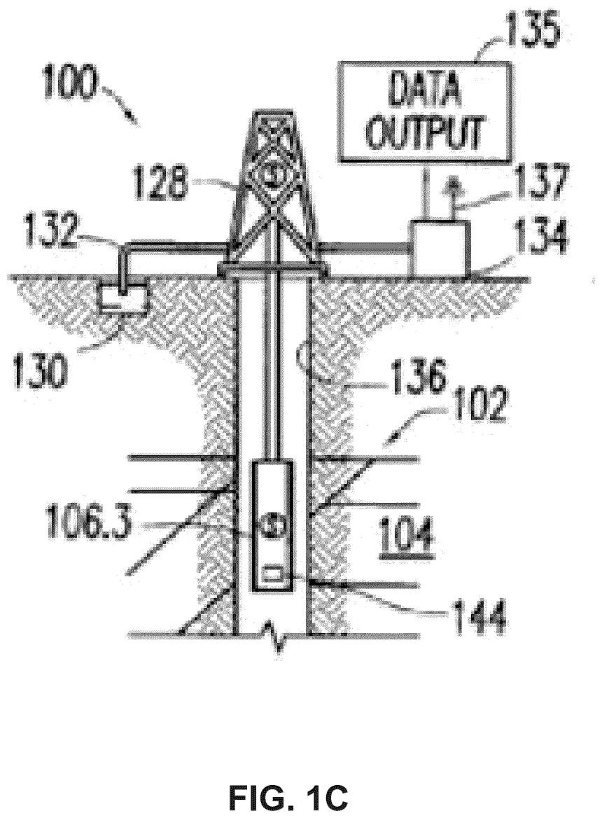

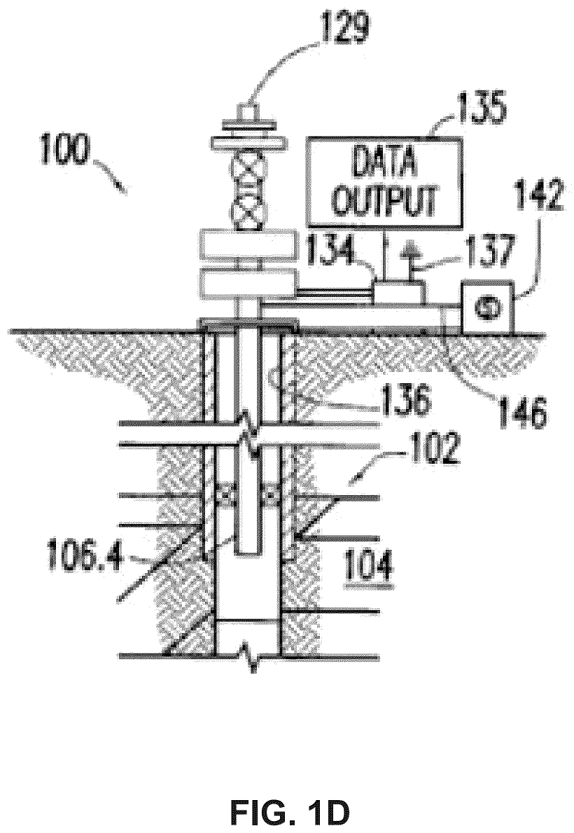

FIGS. 1A-1D are schematic views of an oilfield.

FIGS. 1A-1D illustrate simplified, schematic views of an example oilfield 100 having subterranean formation 102 containing reservoir 104 therein in accordance with implementations of various technologies and techniques described herein.

FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals and to receive signals from the surface using a communications channel such as mud pulse telemetry, electromagnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories, and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106.3 to measure downhole parameters which relate to, for example porosity, permeability, fluid composition, and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water, and/or sea. Also, while a single field measured at a single location is depicted, oilfield applications may be utilized with any combination of one or more oilfields, one or more processing facilities and one or more wellsites.

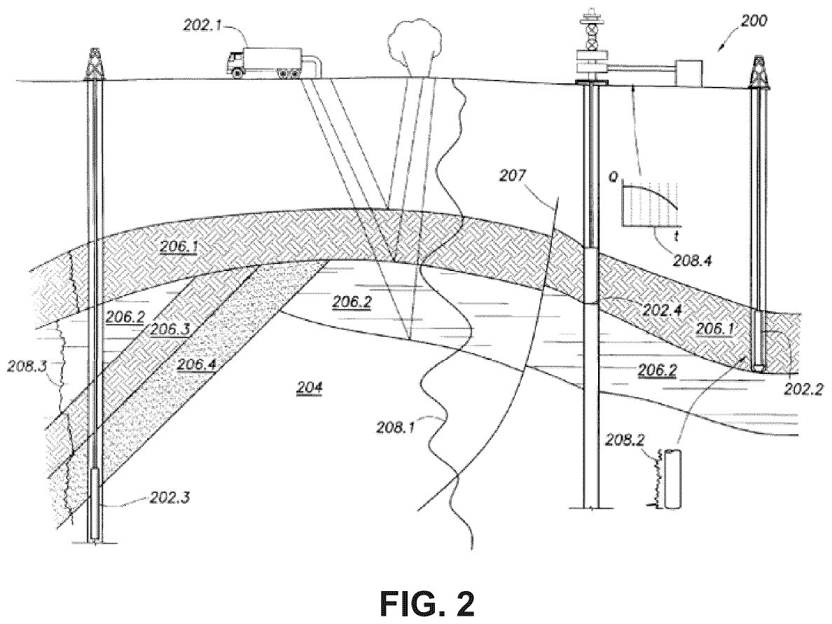

FIG. 2 is a schematic view of an example oilfield.

FIG. 2 illustrates a schematic view, partially in cross-section, of an example oilfield 200 having data acquisition tools 202.1, 202.2, 202.3, and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and/or viscosity may be performed on the fluids in the core at varying pressures and temperatures. Static data plot 208.3 is a logging trace that may provide a resistivity or other measurement of the formation at various depths.

A production decline curve or graph 208.4 is a dynamic data plot of the fluid flow rate over time. The production decline curve may provide the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean formation 204 has a plurality of geological formations 206.1-206.4. As shown, this structure has several formations or layers, including a shale layer 206.1, a carbonate layer 206.2, a shale layer 206.3, and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Seismic data displayed in static data plot 208.1 from data acquisition tool 202.1 may be used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

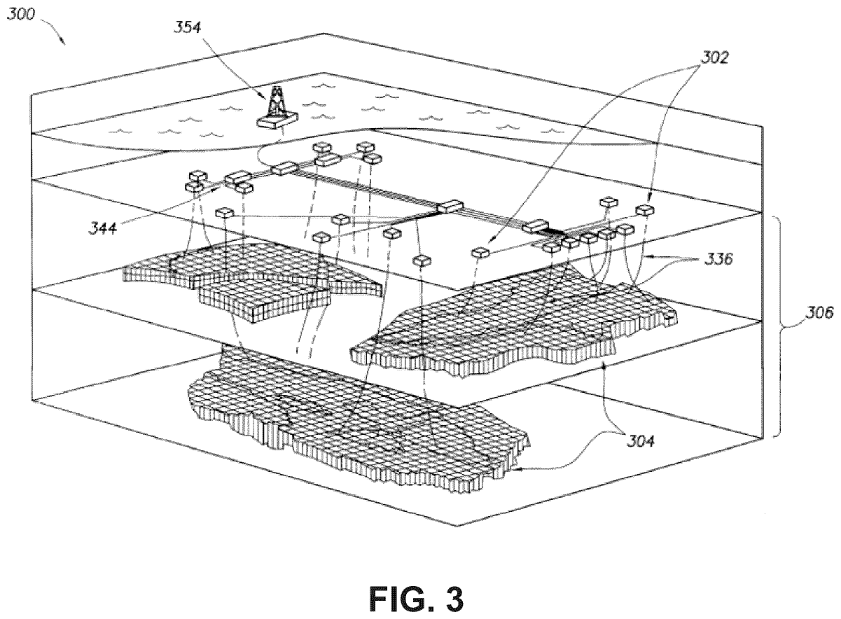

FIG. 3 is a schematic view of an example oilfield.

FIG. 3 illustrates an example oilfield 300 for performing production operations in accordance with implementations of various technologies and techniques described herein. As shown, the oilfield has a plurality of wellsites 302 operatively connected to central processing facility 354. The oilfield configuration of FIG. 3 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

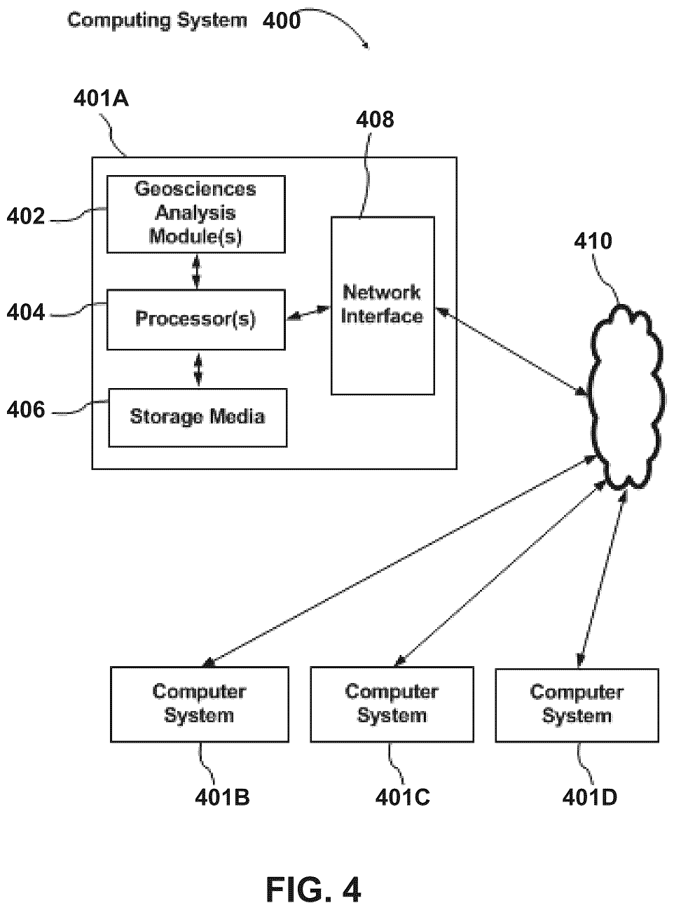

FIG. 4 is a schematic view of an example computing system.

FIG. 4 depicts an example computing system 400 in accordance with some embodiments. The computing system 400 can be an individual computer system 401A or an arrangement of distributed computer systems. The computer system 401A includes one or more geosciences analysis modules 402 that are configured to perform various tasks according to some embodiments, such as one or more methods disclosed herein. To perform these various tasks, geosciences analysis module 402 executes independently, or in coordination with, one or more processors 404, which is (or are) connected to one or more storage media 406. The processor(s) 404 is (or are) also connected to a network interface 408 to allow the computer system 401A to communicate over a data network 410 with one or more additional computer systems and/or computing systems, such as 401B, 401C, and/or 401D (note that computer systems 401B, 401C, and/or 401D may or may not share the same architecture as computer system 401A, and may be located in different physical locations, e.g., computer systems 401A and 401B may be on a ship underway on the ocean, while in communication with one or more computer systems such as 401C and/or 401D that are located in one or more data centers on shore, other ships, and/or located in varying countries on different continents). Note that data network 410 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device. The term “processor” may refer to a single processor or may include multiple processors and/or sub-processors.

The storage media 406 can be implemented as one or more computer-readable or machine-readable storage media. Note that while in the example embodiment of FIG. 4 storage media 406 is depicted as within computer system 401A, in some embodiments, storage media 406 may be distributed within and/or across multiple internal and/or external enclosures of computing system 401A and/or additional computing systems. Storage media 406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 401A is one example of a computing system, and that computer system 401A may have more or fewer components than shown, may combine additional components not depicted in the example embodiment of FIG. 4, and/or computer system 401A may have a different configuration or arrangement of the components depicted in FIG. 4. The various components shown in FIG. 4 may be implemented in hardware, software, or a combination of both, hardware and software, including one or more signal processing and/or application specific integrated circuits.

It should also be appreciated that while no user input/output peripherals are illustrated with respect to computer systems 401A, 401B, 401C, and 401D, many embodiments of computing system 400 include computer systems with keyboards, mice, touch screens, displays, etc. Some computer systems in use in computing system 400 may be desktop workstations, laptops, tablet computers, smartphones, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

Attention is now directed to methods, techniques, and workflows for planning, forecasting, and/or optimizing production related systems (e.g., model selections, reservoir maps, wells, etc.) in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 400, FIG. 4), and/or through manual control by a user who may make determinations regarding whether a given step, operation, action, template, or model has become sufficiently accurate.

A distributed data platform, such as the Open Group Subsurface Data Universe (OSDU®), may act to reduce data silos which, in turn, may enable workflows in an efficient manner. Considering these benefits, an entity, such as an energy company, as a part of their digital journey may adopt a data platform (e.g., OSDU) for all or most of their data. In some cases, the data may be energy-related data, such as well data or other subsurface data.

In an example embodiment, an energy company may ingest data, in some embodiments as mentioned above, well data from disparate data sources into a first managed data platform (e.g., a fully managed set of services built on OSDU) and the ingested data may be consumed by different applications (e.g., energy-related applications). The modified data from the consumption applications then may be liberated back to the first managed data platform.

Example embodiments may provide a pipeline to transfer (or migrate) data, which may be type-based, e.g., Kind-based, storage records. Example embodiments may provide a migration pipeline for core OSDU document storage, file storage, and/or record comparison. Example embodiments may also provide one or more pipelines for data extraction and transformation, transferring access control lists (ACLs), legal tag migrations, storage records, data management service (DMS) data, filtering/selection of the data, and/or data validation and comparison. Example embodiments may provide a migration pipeline for DMS bulk data, e.g., domain data management service (DDMS) bulk data. Example embodiments may provide one or more interfaces, e.g., dashboards, e.g., POWER BI® dashboards, for migrated data validation.

As an extension to their digital journey, the energy company may decide to move to a second managed data platform (for example, an enterprise-ready data platform, such as AZURE® Data Manager for Energy (ADME) PaaS Service provided by Microsoft). To accomplish this, the energy company's data may need to be migrated from the first managed data platform to the second managed data platform. For example, the energy company may migrate well data (e.g., Well headers, Deviation, Markers & Log Curves) from a fully managed set of services built on OSDU to the ADME PaaS Service.

Example embodiments may provide a solution for migration and synchronization of data between two data platforms, e.g., OSDU data platforms or OSDU data partitions. Example embodiments may provide a scalable data pipeline capable of handling complex data processing with little to no user intervention. Example embodiments may ensure thorough validation of migrated data.

An automated solution to accomplish such a migration may perform some or all the following tasks:
a. Legal tags and Access controls.
b. Reference data.
c. Custom schemas.
d. Migrate bulk data the File Generic.
e. Migrate data types, such as Well headers, Deviation Surveys, Markers and Log Curves.
f. Latest versions of the records from RAW, Well-Known Schemas (WKS), Well Known Entity (WKE).
g. Migrate bulk data from a DMS of the first data platform to a DMS of the second data platform, for example, from a Wellbore Domain Management Services (WBDMS) of a first OSDU to a WBDMS of a second OSDU.
h. Synchronize the data between first managed data platform and second managed data platform.

The entire data migration process may be automated. The process should be able to extract the data from the first managed data platform and ingest to the second managed data platform.

Validation of the migrated data is an important task in any data migration. The process utilized for the data migration may do the statistical validation of the migrated data. Along with the statistical validation, the process may compare the records of the first managed data platform and the second managed data platform at the level of attribute and its values. The number of records that is to be compared may be a user-defined variable, in some embodiments, based on which random records are fetched from the first managed data platform and are compared with the second managed data platform at their attributes/values level.

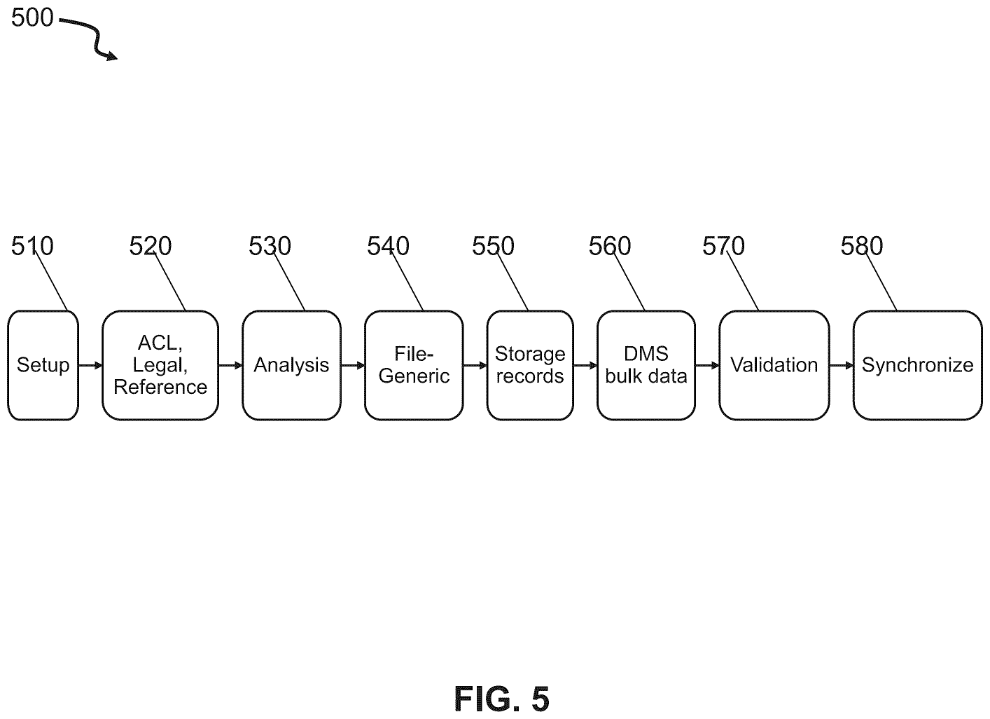

Performance testing may be another important step in some embodiments, which may give an idea on the throughput that one can expect in the production environment. An optimum parameter for better throughput may be one potential deliverable of the performance testing. FIG. 5 is flowchart for an example workflow.

FIG. 5 shows an example workflow 500. The example workflow 500 may include, at block 510, a setup operation, which may include create a virtual machine (VM) on a cloud service provider subscription, e.g., with given hardware and software specifications. The example workflow 500 may further include, at block 520, migration of access control list (ACL), legal tags, and reference data from the first data platform to the second data platform. The example workflow 500 may further include, at block 530, an analysis of the Kinds involved in the scope of data migration. The term “Kinds” refers to data types, which may be OSDU-specific. Some nonlimiting examples of Kinds may include data related to “SeismicTraceData”, “SeismicBinGrid”, “Seismic3DInterpretationSet”, “Filecollections.slb.OpenZGY, Filecollections.SEGY” etc. The example workflow 500 may further include, at block 540, creating a file-generic data migration pipeline between the first data platform and the second data platform. The example workflow 500 may further include, at block 550, fetching storage records from the first data platform. The example workflow 500 may further include, at block 560, DMS bulk data migration, such as wellbore domain management services (WBDMS) bulk data migration, from the first data platform to the second data platform. The example workflow 500 may further include, at block 570, validation of the migrated data in the second data platform. The example workflow 500 may further include, at block 580, synchronization of the migrated data in the second data platform with any changes made to the original data in the first data platform.

Some examples for each task in the sequence of the example workflow 500 are shown in Table 1 below.

TABLE 1

| Task | Action Plan | |
|---|---|---|
| Setup (Block | 1) | Create a VM on cloud service provider (e.g., |
| 510) | | AZURE ®) subscription with given hardware and |
| | | software specifications. |
| ACL migration | 1) | Check the access to the available ACL groups. |
| (Block 520) | 2) | Create ACL groups in the second managed data |
| | | platform (e.g., ADME) which is required for the |
| | | migration of selected sample data. |
| Legal tag | 1) | Check if the Legal tags are changed or not. |
| migration | 2) | If the Legal tags are changed prepare the mapping |
| (Block 520) | | between first managed data platform and second |
| | | managed data platform tags. |
| | 3) | Add the Legal tags required for sample data in the |
| | | second managed data platform. |
| References | 1) | Check if reference data is added or modified. |
| migration | 2) | Analyze to create query which can be used to find |
| (Block 520) | | out what is modified. |
| Analysis | 1) | Analyze the Kinds involved in the scope of data |
| (Block 530) | | migration. |
| | 2) | Create a hierarchical data model of the Kinds to |
| | | decide the order of ingestion. |
| | 3) | Decide the scope of ancestry migration as per |
| | | above data model. |
| File-generic | 1) | The pipeline may download the files for given set |
| data migration | | of record identifications (IDs) of the first |
| pipeline | | managed data platform and ingest it into the |
| (Block 540) | | second managed data platform, during this |
| | | process, the pipeline may populate migration |
| | | database with the mapping information about |
| | | record ID and version from source and target. |
| | 2) | The pipeline may use the above-mentioned |
| | | mapping during the migration of records from |
| | | storage service. |
| Custom schema | 1) | Schema of custom Kind from the first managed |
| migration | | data platform to the second managed data |
| pipeline | | platform. |
| (Block 550) | 2) | Run pipeline to migrate sample record of custom |
| | | Schema |
| RAW, WKS, | 1) | Refer to hierarchical data model to decide the |
| WKE, Work | | order of ingestion for the selected Kinds. |
| Product | 2) | Select one Kind at time. |
| Component | 3) | Fetch record IDs and iterate a list of sample |
| (WPC) | | WPC record IDs. |
| metadata | 4) | Transform the record |
| migration | | a) Change ACL as per new tenant ID |
| pipeline | | b) Change Legal tag only if it is changed |
| (Block 550) | | c) Remove version from record IDs mentioned |
| | | in the relationship |
| | | d) Keep ancestry records as per decision made |
| | | in the analysis phase |
| | | e) Change version ID for the records mentioned |
| | | in the ancestry. |
| | 5) | Ingest record. |
| WBDMS | 1) | Iterate list of sample WPC record IDs to fetch |
| records | | bulk data associated. |
| migration | 2) | Ingest bulk data into the second managed data |
| pipeline | | platform. |
| (Block 560) | | |
| Match and | 1) | Check & migrate if match & merge rules are used |
| Merge rules | | for WKE generation service in first managed data |
| migration | | platform. |
| (Block 560) | | |
| WKS mappings | 1) | Analyze the mapping. |
| migration | | |
| (Block 560) | | |
| Validation | 1) | Use search service APIs to fetch record counts of |
| (Block 570) | | all Kinds in both the first managed data platform |
| | | and the second managed data platform tenant and |
| | | compare them. |
| | 2) | Compare the attribute count, names, and its values |
| | | for a selected record in both the first managed data |
| | | platform and the second manged data platform. |
| | 3) | Visual validation of randomly selected data in an |
| | | application (e.g., PETREL ®/TECHLOG ®) |
| | | project pointing to the second managed data |
| | | platform. |
| Synchroniza- | 1) | Synchronization between the first managed data |
| tion (Block | | platform and the second managed data platform |
| 580) | | for predetermined period of time. |

Migration pipelines in accordance with example embodiments may perform the following activities:
a. Custom Schema pipelines may be written to migrate non-OSDU authority schemas.
b. File-generic pipelines may be written to migrate file sources under file-generic Kind.
c. Records extracted for example in JavaScript Object Notation (JSON) formats, which may be a generic format for all Kinds may be provided to migrate storage records (e.g., in JSON formats), support references, master records, raw records, work product component (WPC) records (e.g., for WPC support for WBDMS-based dataset references), etc. Supporting record identification (ID)-based and query-based query options may be provided. For example, selection of records may include an option to setup a filter based on a query, and may automatically decide the number of records in each batch, e.g., based on the average size of the record for that data type.
d. Bulk data pipelines may be written to migrate bulk data from the DMS of a first data platform (e.g., OSDU) to the DMS of a second data platform (e.g., OSDU). For example, WBDMS Bulk data pipelines may be written to migrate bulk data for Trajectories and Well logs stored in the WBDMS.
e. Session-based pipelines may be written for bulk data migration of large bulk files from the DMS, e.g., WBDMS.
f. A Log Recognition service may be written to migrate custom catalogue for log recognition service.

Dataflow Architecture in accordance with example embodiments may be broadly classified into three parts: Extraction, Transformation, and Loading/Ingestion. Examples of each are given below:

a. Extraction
i. Record IDs for a selected data type, e.g., Kind, may be fetched from first managed data platform using the data platform (e.g., OSDU) search service, such as a specific query-based service. Fetched record IDs are saved in a database (e.g., POSTGRESQL® database).
ii. Fetching of storage records for a selected record ID using storage services.
iii. Details regarding the IDs fetched and their latest version may be stored in the database, along with status codes.
   b. Transformation
i. Records may be transformed for changes in ACL domains, Legal tags, Ancestry references, under data block the IDs referring to any specific version may be removed, and ID references that cannot be retained in the second managed data platform may be replaced for, e.g., file-generic, for example, a Uniform Resource Identifier (URI), such as bulkURI, whose IDs/references may be generated based on unique identifiers, such as Universally Unique Identifiers (UUIDs). The records may be transformed from a first data format compatible with the first data platform to a second data format compatible with the second data platform using the ACL groups, any changed legal tags, and record IDs.
ii. Information regarding success/failure and modifications etc. may be captured in the database (e.g., POSTGRESQL® database) and errors may be captured on logs, e.g., NIFI™ logs.
   c. Loading/Ingestion
i. Ingestion may be done in batches, each batch may also be given a unique correlation ID.
ii. Information regarding success/failure may be captured in the database (e.g., POSTGRESQL® database).
iii. Retry may be done for any failed batches based on failure information is captured in the database (e.g., POSTGRESQL® database).

For a DMS, bulk files, e.g., WBDMS, Data, files, e.g., APACHE PARQUET™ files, may be fetched from a bulk endpoint, and may be ingested via the second managed data platform bulk endpoint. Registration of BulkURI in the WPC may be performed. Migration details may be captured in a database along with the failures, which may be sent through a retry approach. Large files may be filtered and sent to a session-based ingestion logic, and the large files may be broken into smaller chunks and ingested.

File-generic migration may be similar to JSON records migration, with an additional step in which a download Uniform Resource Locator (URL) may be generated, and the file may be downloaded in a staging area and may be uploaded without any transformation. These files may be deleted automatically from the staging area after they are uploaded to the second managed data platform. Details may be captured in a database, and failure information may also be captured and sent to retry.

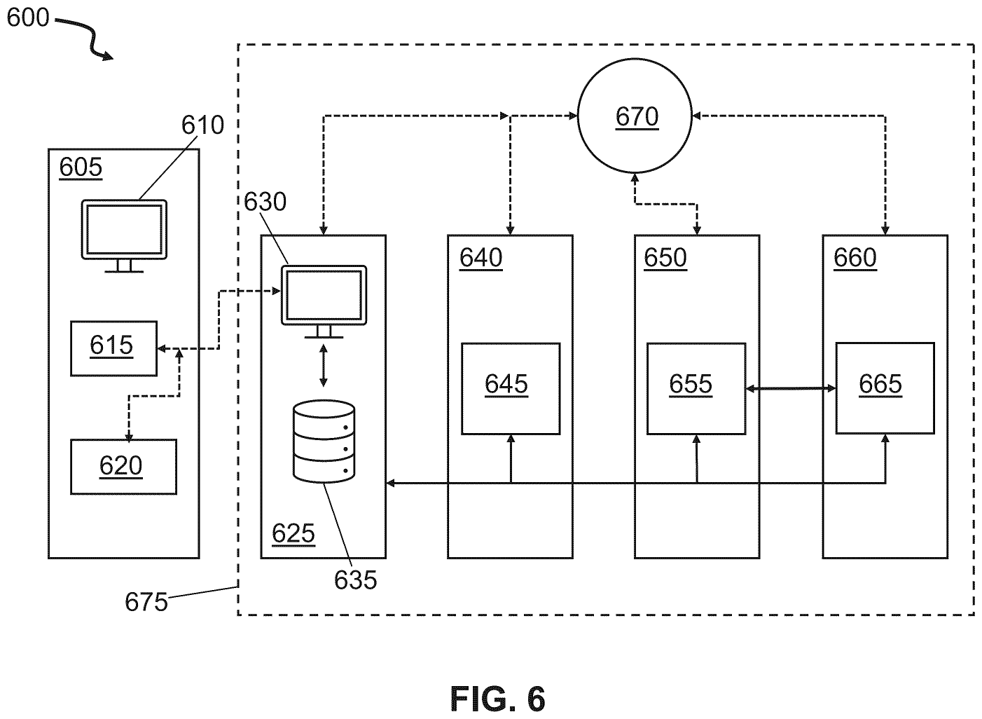

FIG. 6 is a schematic view of an example data architecture.

FIG. 6 shows an example data architecture 600, which may include a control block 605, which may include a control interface 610, which may control an administration and development platform 615 that may provide a graphical user interface (GUI) 620 that may allow users to interact with databases, e.g., through a web browser or desktop application. The control block 605 may communicate with a data integration block 625, which may include a data integration application 630, for example, NIFI™, e.g., to automate and manage the flow of data between systems, and a database 635, which may be, for example, a shared drive, a cloud drive, or any other computer memory capable of storing bulk data. The data integration block 625 may communicate with a first subscription block 640, which may include an OSDU data platform 645, for example, pre-platform-as-a-service (Pre-PaaS), managed planning data foundation (MPDF) data platform, or LUMI®. The first subscription block 640 may provide an intermediate architecture and workflow(s) to prepare legacy and/or on-premises data for ingestion into a data platform, for example, a cloud-native platform-as-a-service (PaaS) environment. The data integration block 625 may also communicate with a second subscription block 650, which may include a first data platform 655, e.g., ADME, and a third subscription block 660, which may include second data platform 665, for example, an enterprise data solution, e.g., SLB ENTERPRISE DATA SOLUTION® (SEDS), which may run in conjunction with a second data platform, e.g., OSDU. Each of the first, second, and third subscription blocks 640, 650, and 660 may also communicate with each other. Each of the data integration block 625 and the first, second, and third subscription blocks 640, 650, and 660 may communicate with a digital platform 670 for integrating data, applications, and workflows, for example, DELFI® as a nonlimiting example. The example data architecture 600 can provide data migration between the first data platform 655 and the second data platform 665, for example, using the processes described in accordance with example embodiments. The data integration block 625, the first subscription block 640, the second subscription block 650, the third subscription block 660, and the digital platform 670 may be generally included in a data center 675.

Performance testing may be performed to determine the optimum parameters for number of records per request and the number of such concurrent requests that can be triggered. In an experimental test using an example embodiment, the total number of records considered for the performance testing was about 123,000. However, different scenarios were also tested and the final details of the same is given in Table 2 below.

TABLE 2

| | Search | Fetch (Extract) | | | | Transform | Ingest | | | |
|---|---|---|---|---|---|---|---|---|---|---|
| Batch Size\ | 1 | 1 | 50 | 100 | 200 | 20 | 1 | 50 | 100 | 200 |
| Concurrency | | | | | | | | | | |
| 20 | 1860 sec | | | 80 | 130 sec | 840 sec | | 900 | 600 | |
| | | | | sec | | | | sec | sec | |
| 50 | 840 sec | 1740 | 53 | 56 | 28 sec | 420 sec | 5220 | 360 | 300 | |
| | | sec | sec | sec | | | sec | sec | sec | |
| 100 | 480 sec | 1440 | 62 | 37 | 29 sec | 480 sec | 2580 | 330 | Server | |
| | | sec | sec | sec | | | sec | sec | Error | |
| 150 | Bad | | | | | | | | | |
| | Request | | | | | | | | | |

When all the tasks are performed in parallel, which may be done in some embodiments, the performance numbers are as given below. In an embodiment, with concurrency as listed below, time taken to migrate 123,000 records from the first managed data platform, e.g., the first data platform 655 of FIG. 5, to the second managed data platform, e.g., the second data platform 665 of FIG. 5, is as given below in Table 3.

TABLE 3

| | |
|---|---|
| NIFI ™ Max Concurrency | 100 |
| Fetch (Extract) | 100 |
| Transform | 50 |
| Ingest | 50 |
| Total Time | 25 mins |

Using the above parameters, in an example in which the total number of records is around 4.1 million, it may take around 12 hours of time to migrate the data from the first managed data platform to the second managed data platform. This is a significant improvement over conventional data migration solutions, which may take anywhere from 10 to 20 days for that amount of data. Moreover, concurrency can be tuned. Concurrency may be set up for parallel ingestion of records within a batch for a better performance as per VM infrastructure and applicable API rate limit.

Validation of the migrated data from the first managed data platform to the second managed data platform may be done in three different ways, for example: (a) statistical validation; (b) attribute validation; and (c) visual quality control (QC).
a. Statistical Validation: Pipelines may be written to get the count of data in the first managed data platform and the second managed data platform, this information is compared for validation purpose. The database may contain the information pertaining to failures along with the possible reason, e.g., wherever possible. Statistical validation gives the information on the count of data that is migrated to the second managed data platform, reasons for failures, if any. The statistical information may be captured in the database and the same may be displayed in one or more interfaces, e.g., GUIs, each of which may be, for example, a dashboard or other interface application, e.g., a business analytics platform, for example, POWER BI®).
b. Attribute Validation: In the statistical validation, only the count of records may be compared between the first managed data platform and the second managed data platform. In the attribute validation, a user may be given an option to select the number of records to compare, based on the number that the user chose, the records in the first managed data platform are randomly selected, the pipeline may check the number of attributes in the selected record and values of the attributes in the selected record, this information may be compared with the migrated record in the second managed data platform. There may be a few attributes that would be different in the migrated record of the second managed data platform (e.g., version, created by, created date, bulkURI, file-generic ID, etc.), but the rest of the attributes of the selected record should match. If there are any mismatches, the pipeline may capture the mismatch(es). Because the comparison of the records at the attribute level is time consuming, it is recommended to select a reasonable number of records for attribute-level validation.
c. Visual quality control (QC): In the case of visual QC validation, the data that is migrated to the second managed data platform may be consumed (ingested) in an application. Visual QC may be done by importing some random sampled data from second managed data platform, and the sampled data may be checked.

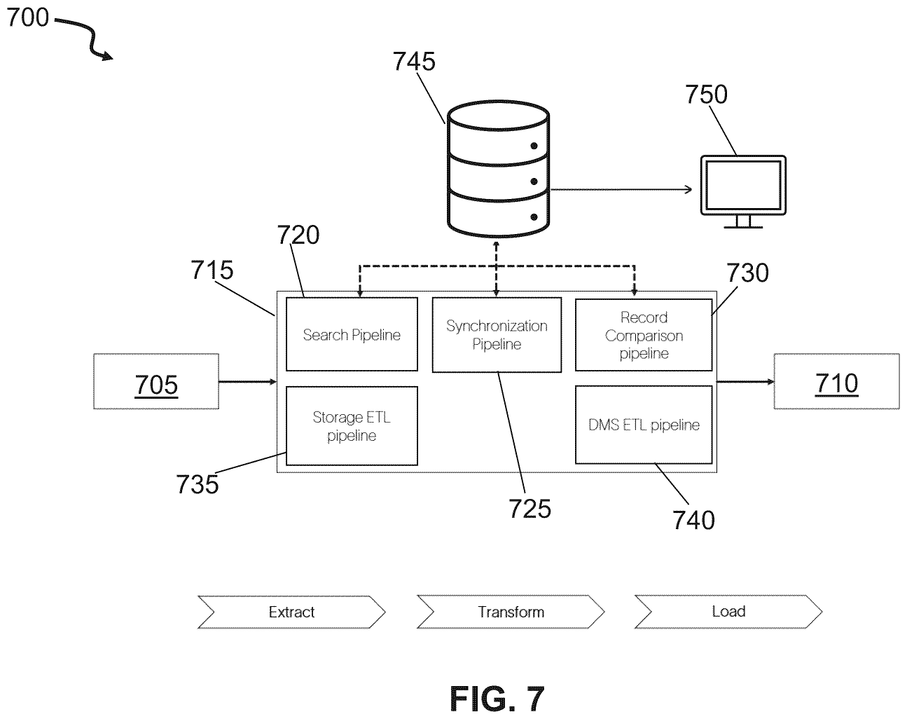

FIG. 7 is a schematic of an example solution architecture.

FIG. 7 shows an example solution architecture 700 for migrating data from a first data platform 705 to a second data platform 710. Both of the first data platform 705 and the second data platform 710 may be OSDU data platforms. However, example embodiments are not limited thereto. An orchestration framework 715, which may be implemented on, for example, NIFI™ may provide the extract, transform, and loading (or ingestion) functions described above. For example, the orchestration framework 715 may include a search pipeline 720, a synchronization pipeline 725, a record comparison pipeline 730, a storage extract-transform-load (ETL) pipeline 735, and a data management system (DMS) ETL pipeline 740. The search pipeline 720, synchronization pipeline 725, and record comparison pipeline 730 may communicate with each other and with database 745, which may be, for example a POSTGRESQL® database. The database 745 may communicate with one or more interfaces 750, e.g., GUIs, each of which may be, for example, a dashboard or other interface application, e.g., a business analytics platform, for example, POWER BI®).

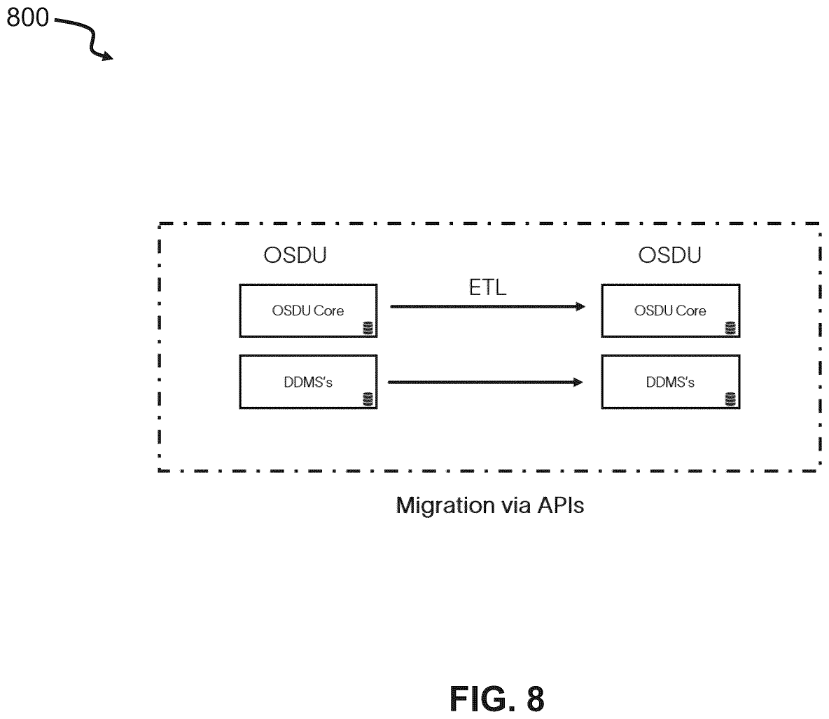

FIG. 8 is a schematic of an example data migration strategy.

In FIG. 8, an example data migration strategy 800 includes migration via application programming interfaces (APIs) from a first OSDU to a second OSDU. Each OSDU may include a respective OSDU core and domain data management service (DDMS). The migration may be performed via extract-transform-load (ETL) APIs between the respective OSDU cores and DDMSs.

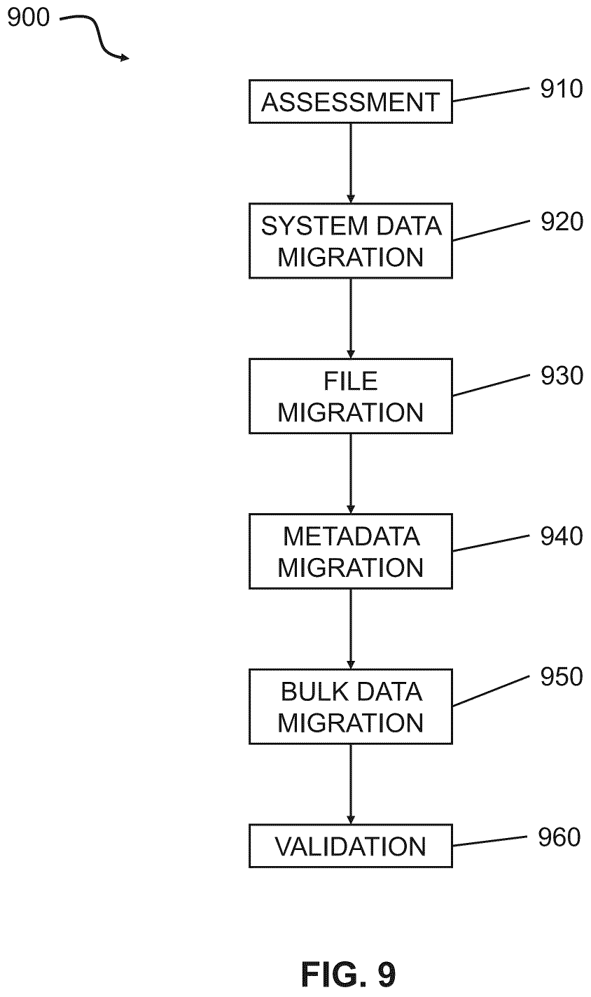

FIG. 9 is flowchart for an example workflow.

In FIG. 9, an example workflow 900 may include, at block 910, an assessment, which may include analyzing data to determine hierarchy and dependency. The example workflow 900 may further include, at block 920, system data migration, which may include migrating ACLs, legal tags, and identifying custom data Kinds and/or Schema. The example workflow 900 may further include, at block 930, file migration, which may include files being stored in a file service. The example workflow 900 may further include, at block 940, metadata migration, which may include migrating custom Schemas and raw, WKS, and WPC data migration. The example workflow 900 may further include, at block 950, bulk data migration, which may include DDMS, bulk data migration. The example workflow 900 may further include, at block 960, validation, which may include validating counts. The validation may be implemented, as nonlimiting examples, using a data management layer or interface in which users can interact with structured data (e.g., well logs, seismic metadata) during migration or validation workflows, or a subsurface software tool as a source environment for well data, such as PETREL® or TECHLOG®.

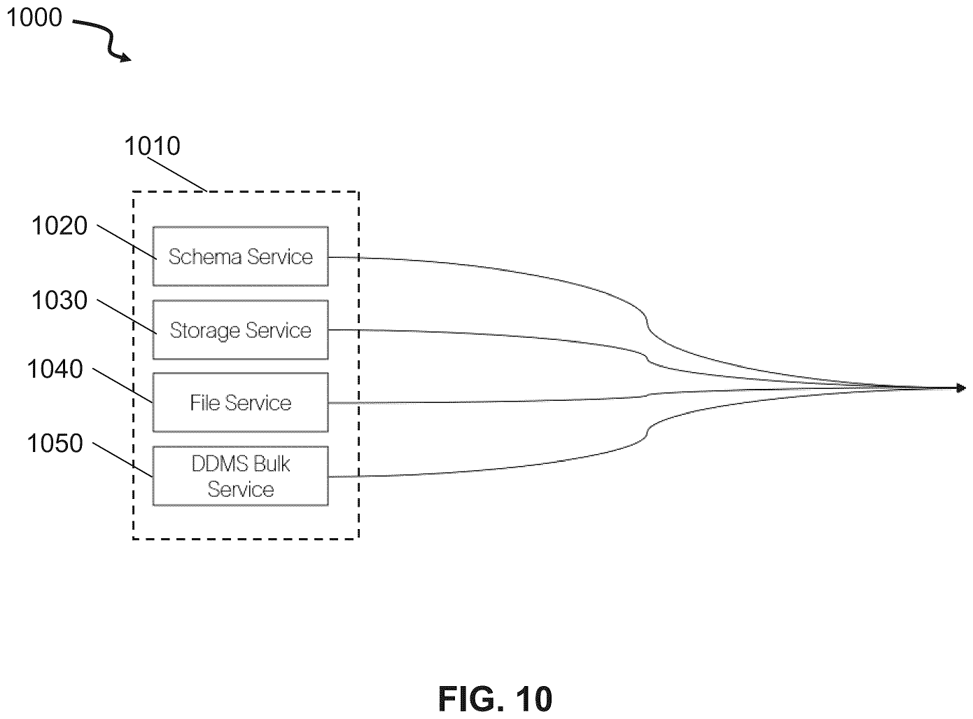

FIG. 10 is a flowchart for an example extraction workflow.

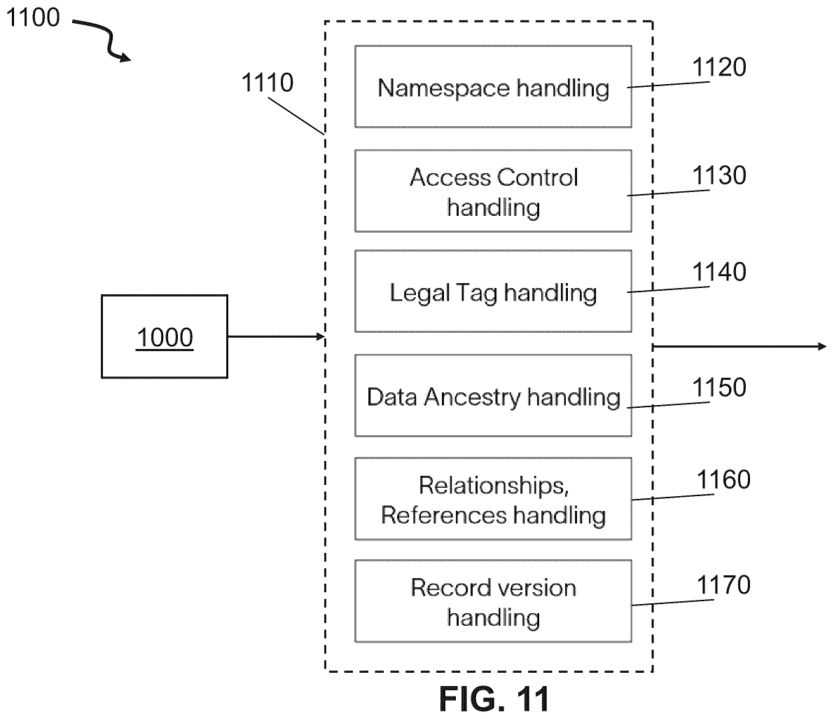

In FIG. 10, an example extraction workflow 1000 may include using various communication services 1010, which may include, a schema service 1020, a storage service 1030, a file service 1040, and a DDMS bulk service 1050, to extract data to be migrated from a first data platform, e.g., the first data platform 705 of FIG. 7 to a second data platform, e.g., the second data platform 710 of FIG. 7. The communication services 1010 may implement, for example, Representational State Transfer (“RESTful”) services to enable communication between systems. FIG. 11 is a flowchart for an example transformation workflow.

In FIG. 11, an example transformation workflow 1100 may include a handling block 1110 for transforming data extracted by the example extraction workflow 1000. The handling block 1110 may include one or more transformation handling types, for example, namespace handling 1120, access control handling 1130, legal tag handling 1140, data ancestry handling 1150, relationships, references handling 1160, and record version handling 1170. The transformed data may then be passed on for loading/ingestion.

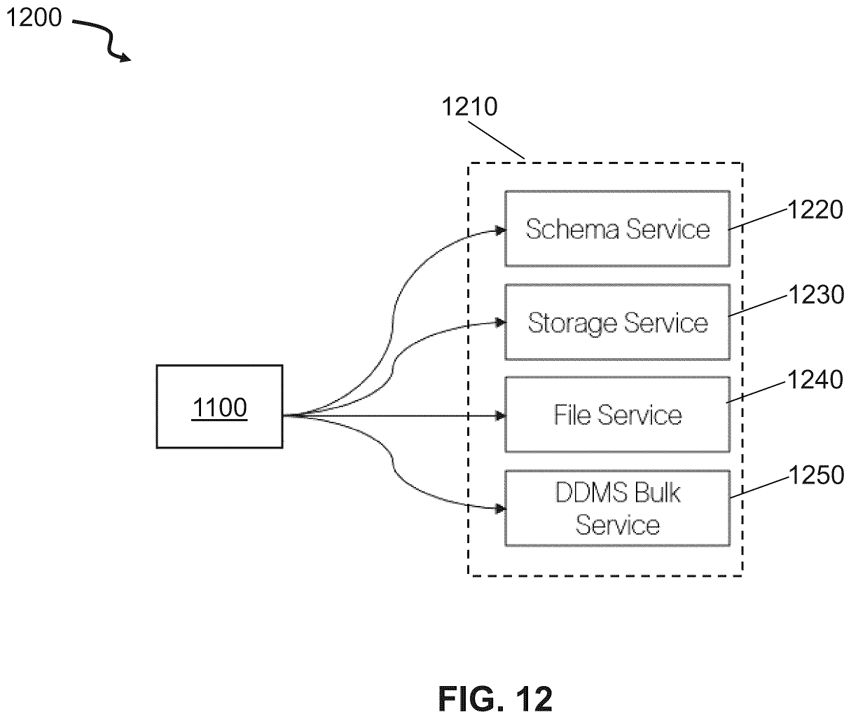

FIG. 12 is a flowchart for an example loading/ingestion workflow.

In FIG. 12, an example extraction loading/ingestion 1200 may include using various communication services 1210, which may include a schema service 1220, a storage service 1230, a file service 1240, and a DDMS bulk service 1250, to load data to be ingested from a first data platform, e.g., the first data platform 705 of FIG. 7 to a second data platform, e.g., the second data platform 710 of FIG. 7, after performing the example transformation workflow 1100. The communication services 1210 may implement, for example, Representational State Transfer (“RESTful”) services to enable communication between systems.

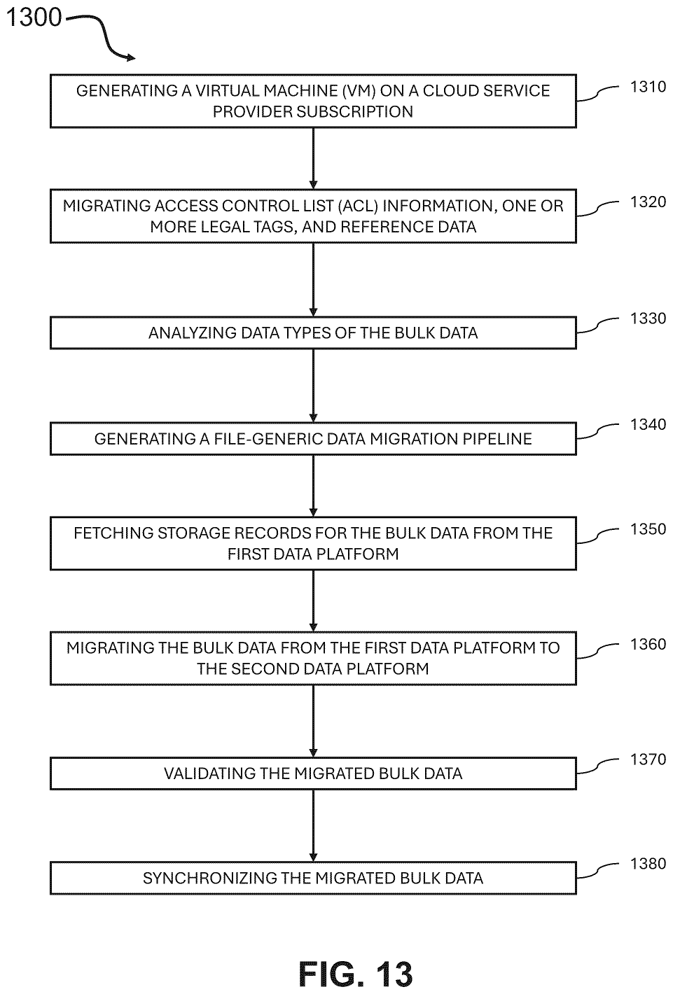

FIG. 13 is an example method according to an example embodiment.

FIG. 13 is a flowchart of an example method 1300 for migrating bulk data from a first data platform to a second data platform. The method 1300 may include, at operation 1310, generating a virtual machine (VM) on a cloud service provider subscription. The method 1300 may further include, at operation 1320, migrating access control list (ACL) information, one or more legal tags, and reference data from the first data platform to the second data platform, using the VM to control the migrating. The method 1300 may further include, at operation 1330, analyzing data types of the bulk data. The method 1300 may further include, at operation 1340, generating a file-generic data migration pipeline from the first data platform to the second data platform, using the VM. The method 1300 may further include, at operation 1350, fetching storage records for the bulk data from the first data platform using the VM. The method 1300 may further include, at operation 1360, migrating the bulk data from the first data platform to the second data platform, using the VM to control the migrating. The method 1300 may further include, at operation 1370, validating the migrated bulk data in the second data platform. The method 1300 may further include, at operation 1380, synchronizing the migrated bulk data in the second data platform with any changes made to the bulk data in the first data platform since the migrating the bulk data began.

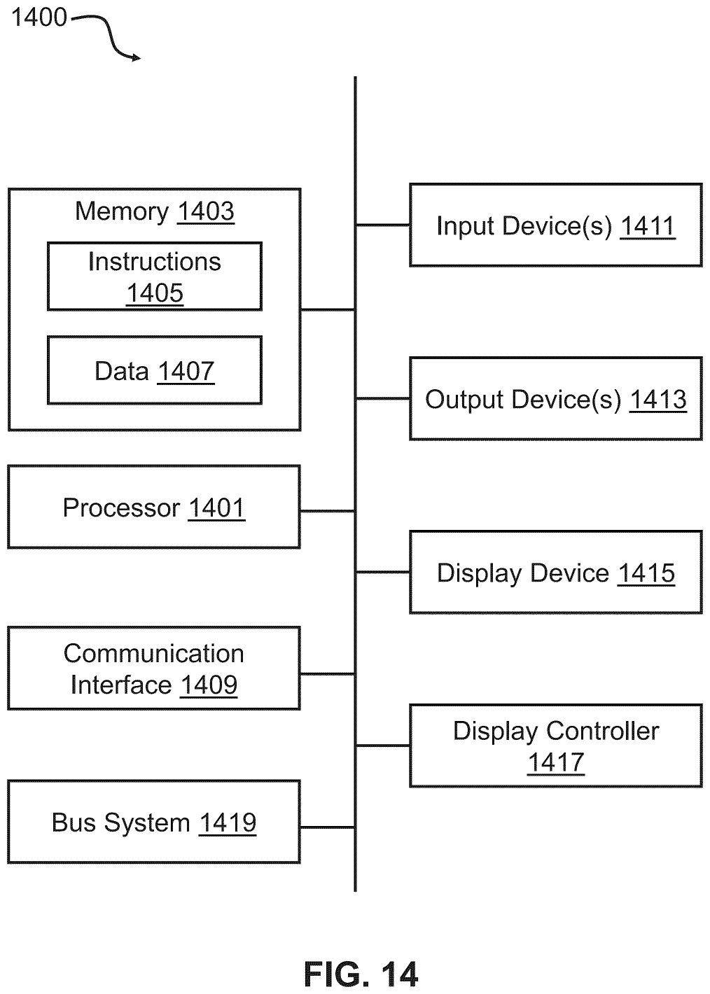

FIG. 14 illustrates certain components that may be included within a computer system according to an example embodiment of the present disclosure.

FIG. 14 illustrates certain components that may be included within a computer system 1400, which may be used to control features according to embodiments of the present disclosure, such as the features discussed with reference to FIGS. 1-13. One or more computer systems 1400 may be used to implement the various devices, components, and systems described herein.

The computer system 1400 includes a processor 1401. The processor 1401 may be a single processor or may include multiple processors and/or sub-processors. The processor 1401 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 1401 may be referred to as a central processing unit (CPU). Although just a single processor 1401 is shown in the computer system 1400 of FIG. 14, in an alternative configuration, a combination of processors (e.g., an ARM and DSP) could be used. In one or more embodiments, the computer system 1400 further includes one or more graphics processing units (GPUs), which can provide processing services related to both entity classification and graph generation.

The computer system 1400 also includes memory 1403 in electronic communication with the processor 1401. The memory 1403 may be any electronic component capable of storing electronic information. For example, the memory 1403 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory may include a single memory devices or multiple memory devices.

Instructions 1405 and data 1407 may be stored in the memory 1403. The instructions 1405 may be executable by the processor 1401 to implement some or all of the functionality disclosed herein. Executing the instructions 1405 may involve the use of the data 1407 that is stored in the memory 1403. Any of the various examples of modules and components described herein may be implemented, partially or wholly, as instructions 1405 stored in memory 1403 and executed by the processor 1401. Any of the various examples of data described herein may be among the data 1407 that is stored in memory 1403 and used during execution of the instructions 1405 by the processor 1401.

A computer system 1400 may also include one or more communication interfaces 1409 for communicating with other electronic devices. The communication interface(s) 1409 may be based on wired communication technology, wireless communication technology, or both. Some examples of communication interfaces 1409 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1400 may also include one or more input devices 1411 and one or more output devices 1413. Some examples of input devices 1411 include a keyboard, mouse, microphone, remote control device, button, joystick, trackball, touchpad, and lightpen. Some examples of output devices 1413 include a speaker and a printer. One specific type of output device that is typically included in a computer system 1400 is a display device 1415. Display devices 1415 used with embodiments disclosed herein may utilize any suitable image projection technology, such as liquid crystal display (LCD), light-emitting diode (LED), gas plasma, electroluminescence, or the like. A display controller 1417 may also be provided, for converting data 1407 stored in the memory 1403 into text, graphics, and/or moving images (as appropriate) shown on the display device 1415.

The various components of the computer system 1400 may be coupled together by one or more buses, which may include a power bus, a control signal bus, a status signal bus, a data bus, etc. For the sake of clarity, the various buses are illustrated in FIG. 14 as a bus system 1419.

The following are sections in accordance with at least one embodiment of the present disclosure:

Clause 1: A method for migrating bulk data from a first data platform to a second data platform, the method including: providing a virtual machine (VM) on a cloud service provider subscription, migrating access control list (ACL) information, one or more legal tags, and reference data from the first data platform to the second data platform, using the VM to control the migrating, analyzing data types of the bulk data, generating a file-generic data migration pipeline from the first data platform to the second data platform, using the VM, fetching storage records for the bulk data from the first data platform using the VM, migrating the bulk data from the first data platform to the second data platform, using the VM to control the migrating, validating the migrated bulk data in the second data platform, and synchronizing the migrated bulk data in the second data platform with any changes made to the bulk data in the first data platform since the migrating the bulk data began.

Clause 2: The method of clause 1, wherein the migrating the access control list (ACL) information, one or more legal tags, and reference data from the first data platform to the second data platform includes: determining access to available ACL groups in the first data platform, creating new ACL groups in the second data platform, determining whether the one or more legal tags are different between the first data platform and the second data platform, in response to the one or more legal tags being determined to be different, mapping a change in the one or more legal tags determined to be different between the first data platform and the second data platform tags, adding the one or more legal tags to the second data platform, determining whether reference data is added or modified between the first data platform and the second data platform, and generating a query for determining which reference data is added or modified between the first data platform and the second data platform.

Clause 3: The method of clause 2, wherein the analyzing data types of the bulk data includes: generating a hierarchical data model of the data types to determine an order of ingestion of the bulk data, and determining a scope of ancestry migration based on the hierarchical data model.

Clause 4: The method of clause 3, wherein the generating the file-generic data migration pipeline includes: downloading files for a given set of record identifications (IDs) of the first data platform and ingesting the files into the second data platform, during the downloading and ingesting of the files, populating a migration database with ID mapping information about the record IDs and version information from the first data platform and the second data platform, and using the ID mapping information during migration of records from a storage service associated with the first data platform.

Clause 5: The method of clause 4, wherein the fetching the storage records for the bulk data includes: generating one or more schema for custom data types from the first data platform to the second data platform, running the file-generic data migration pipeline to migrate sample records corresponding to the custom one or more schema for the custom data types, determining an order of ingestion for the data types based on the hierarchical data model, selecting one data type at a time for ingestion, fetching the record IDs and iterating a list of sample Work Product Component (WPC) record IDs for the records from the storage service, transforming the records from a first data format compatible with the first data platform to a second data format compatible with the second data platform using the ACL groups, any changed legal tags, and record IDs, and ingesting the records.

Clause 6: The method of clause 5, wherein the transforming the records includes: changing each ACL based on a new tenant ID for each ACL, changing any of the one or more legal tags determined to be different, in response to a record ID including a version ID, removing the version ID from the record ID including the version ID, retaining ancestry records based on the determined scope of the ancestry migration, and providing a version ID for the ancestry records.

Clause 7: The method of clause 6, wherein the migrating the bulk data from the first data platform to the second data platform includes: iterating the list of sample WPC record IDs to fetch the bulk data associated with the list, ingesting the bulk data into the second data platform in an order based on the list, determining whether match and merge rules are used for a Well Known Entity (WKE) generation service in the first data platform, in response to determining that match and merge rules are used for the WKE generation service in the first data platform, checking and migrating the bulk data, analyzing mapping of Well-Known Schemas (WKS) associated with the bulk data, and changing a bulk data record ID of at least one associated WPC record using a mapping created at the time of creation of the bulk data.

Clause 8: The method of clause 7, wherein the validating the migrated bulk data in the second data platform includes: implementing search service application programming interfaces (APIs) to fetch record counts of all data types in both the first data platform and the second data platform, comparing the record counts of all data types in the first data platform to the record counts of all data types in the second data platform, comparing an attribute count, a name, and a value for a selected record in both the first data platform and the second data platform, and providing a visual validation of randomly selected migrated data in an application project pointing to the second data platform.

Clause 9: The method of clause 8, wherein the synchronizing the migrated bulk data includes: synchronizing the migrated bulk data in the second data platform with the bulk data in the first data platform for a predetermined period of time, and automatic retrieval of failures from a previous cycle.

Clause 10: The method of clause 9, wherein the fetching the storage records for the bulk data and the migrating the bulk data from the first data platform to the second data platform are performed in parallel.

Clause 11: A system for migrating bulk data from a first data platform to a second data platform, including: the first data platform, the second data platform, one or more processors, and at least one memory including at least one non-transitory computer-readable medium storing instructions that, when executed by at least one of the one or more processors, cause the system to perform operations, the operations including: providing a virtual machine (VM) on a cloud service provider subscription, migrating access control list (ACL) information, one or more legal tags, and reference data from the first data platform to the second data platform, using the VM to control the migrating, analyzing data types of the bulk data, generating a file-generic data migration pipeline from the first data platform to the second data platform, using the VM, fetching storage records for the bulk data from the first data platform using the VM, migrating the bulk data from the first data platform to the second data platform, using the VM to control the migrating, validating the migrated bulk data in the second data platform, and synchronizing the migrated bulk data in the second data platform with any changes made to the bulk data in the first data platform since the migrating the bulk data began.

Clause 12: The system of clause 11, wherein the migrating the access control list (ACL) information, one or more legal tags, and reference data from the first data platform to the second data platform includes: determining access to available ACL groups in the first data platform, creating new ACL groups in the second data platform, determining whether the one or more legal tags are different between the first data platform and the second data platform, in response to the one or more legal tags being determined to be different, mapping a change in the one or more legal tags determined to be different between the first data platform and the second data platform tags, adding the one or more legal tags to the second data platform, determining whether reference data is added or modified between the first data platform and the second data platform, and generating a query for determining which reference data is added or modified between the first data platform and the second data platform.

Clause 13: The system of clause 12, wherein the analyzing data types of the bulk data includes: generating a hierarchical data model of the data types to determine an order of ingestion of the bulk data, and determining a scope of ancestry migration based on the hierarchical data model.

Clause 14: The system of clause 13, wherein the generating the file-generic data migration pipeline includes: downloading files for a given set of record identifications (IDs) of the first data platform and ingesting the files into the second data platform, during the downloading and ingesting of the files, populating a migration database with ID mapping information about the record IDs and version information from the first data platform and the second data platform, and using the ID mapping information during migration of records from a storage service associated with the first data platform.

Clause 15: The system of clause 14, wherein the fetching the storage records for the bulk data includes: generating one or more schema for custom data types from the first data platform to the second data platform, running the file-generic data migration pipeline to migrate sample records corresponding to the custom one or more schema for the custom data types, determining an order of ingestion for the data types based on the hierarchical data model, selecting one data type at a time for ingestion, fetching the record IDs and iterating a list of sample Work Product Component (WPC) record IDs for the records from the storage service, transforming the records from a first data format compatible with the first data platform to a second data format compatible with the second data platform using the ACL groups, any changed legal tags, and record IDs, and ingesting the records.

Clause 16: The system of clause 15, wherein the transforming the records includes: changing each ACL based on a new tenant ID for each ACL, changing any of the one or more legal tags determined to be different, in response to a record ID including a version ID, removing the version ID from the record ID including the version ID, retaining ancestry records based on the determined scope of the ancestry migration, and providing a version ID for the ancestry records.

Clause 17: The system of clause 16, wherein the migrating the bulk data from the first data platform to the second data platform includes: iterating the list of sample WPC record IDs to fetch the bulk data associated with the list, ingesting the bulk data into the second data platform in an order based on the list, determining whether match and merge rules are used for a Well Known Entity (WKE) generation service in the first data platform, in response to determining that match and merge rules are used for the WKE generation service in the first data platform, checking and migrating the bulk data, analyzing mapping of Well-Known Schemas (WKS) associated with the bulk data, and changing a bulk data record ID of at least one associated WPC record using a mapping created at the time of creation of the bulk datav.

Clause 18: The system of clause 17, wherein the validating the migrated bulk data in the second data platform includes: implementing search service application programming interfaces (APIs) to fetch record counts of all data types in both the first data platform and the second data platform, comparing the record counts of all data types in the first data platform to the record counts of all data types in the second data platform, comparing an attribute count, a name, and a value for a selected record in both the first data platform and the second data platform, and providing a visual validation of randomly selected migrated data in an application project pointing to the second data platform.

Clause 19: The system of clause 18, wherein the synchronizing the migrated bulk data includes: synchronizing the migrated bulk data in the second data platform with the bulk data in the first data platform for a predetermined period of time, and automatic retrieval of failures from a previous cycle.

Clause 20: The system of clause 19, wherein the fetching the storage records for the bulk data and the migrating the bulk data from the first data platform to the second data platform are performed in parallel.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. Any trademarks mentioned herein are the property of their respective owners. It should be appreciated that the mention of any particular product, file type, data type, or trademark name herein is intended by way of explanation as an example, and is not intended to be limiting to the particularly mentioned product, file type, data type, or trademark subject unless included in the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method for migrating bulk data from a first data platform to a second data platform, the method comprising:
providing a virtual machine (VM) on a cloud service provider subscription;
migrating access control list (ACL) information, one or more legal tags, and reference data from the first data platform to the second data platform, using the VM to control the migrating;
analyzing data types of the bulk data;
generating a file-generic data migration pipeline from the first data platform to the second data platform, using the VM;
fetching storage records for the bulk data from the first data platform using the VM;
migrating the bulk data from the first data platform to the second data platform, using the VM to control the migrating;
validating the migrated bulk data in the second data platform; and
synchronizing the migrated bulk data in the second data platform with any changes made to the bulk data in the first data platform since the migrating the bulk data began.

2. The method of claim 1, wherein the migrating the access control list (ACL) information, one or more legal tags, and reference data from the first data platform to the second data platform comprises:
determining access to available ACL groups in the first data platform;
creating new ACL groups in the second data platform;
determining whether the one or more legal tags are different between the first data platform and the second data platform;
in response to the one or more legal tags being determined to be different, mapping a change in the one or more legal tags determined to be different between the first data platform and the second data platform tags;
adding the one or more legal tags to the second data platform;
determining whether reference data is added or modified between the first data platform and the second data platform; and
generating a query for determining which reference data is added or modified between the first data platform and the second data platform.

3. The method of claim 2, wherein the analyzing data types of the bulk data comprises:
generating a hierarchical data model of the data types to determine an order of ingestion of the bulk data; and
determining a scope of ancestry migration based on the hierarchical data model.

4. The method of claim 3, wherein the generating the file-generic data migration pipeline comprises:
downloading files for a given set of record identifications (IDs) of the first data platform and ingesting the files into the second data platform;
during the downloading and ingesting of the files, populating a migration database with ID mapping information about the record IDs and version information from the first data platform and the second data platform; and
using the ID mapping information during migration of records from a storage service associated with the first data platform.

5. The method of claim 4, wherein the fetching the storage records for the bulk data comprises:
generating one or more schema for custom data types from the first data platform to the second data platform;
running the file-generic data migration pipeline to migrate sample records corresponding to the custom one or more schema for the custom data types;
determining an order of ingestion for the data types based on the hierarchical data model;
selecting one data type at a time for ingestion;
fetching the record IDs and iterating a list of sample Work Product Component (WPC) record IDs for the records from the storage service;
transforming the records from a first data format compatible with the first data platform to a second data format compatible with the second data platform using the ACL groups, any changed legal tags, and record IDs; and
ingesting the records.

6. The method of claim 5, wherein the transforming the records comprises:
changing each ACL based on a new tenant ID for each ACL;
changing any of the one or more legal tags determined to be different;
in response to a record ID including a version ID, removing the version ID from the record ID including the version ID;
retaining ancestry records based on the determined scope of the ancestry migration; and
providing a version ID for the ancestry records.

7. The method of claim 6, wherein the migrating the bulk data from the first data platform to the second data platform comprises:
iterating the list of sample WPC record IDs to fetch the bulk data associated with the list;
ingesting the bulk data into the second data platform in an order based on the list;
determining whether match and merge rules are used for a Well Known Entity (WKE) generation service in the first data platform;
in response to determining that match and merge rules are used for the WKE generation service in the first data platform, checking and migrating the bulk data;
analyzing mapping of Well-Known Schemas (WKS) associated with the bulk data; and
changing a bulk data record ID of at least one associated WPC record using a mapping created at the time of creation of the bulk data.

8. The method of claim 7, wherein the validating the migrated bulk data in the second data platform comprises:
implementing search service application programming interfaces (APIs) to fetch record counts of all data types in both the first data platform and the second data platform;
comparing the record counts of all data types in the first data platform to the record counts of all data types in the second data platform;
comparing an attribute count, a name, and a value for a selected record in both the first data platform and the second data platform; and
providing a visual validation of randomly selected migrated data in an application project pointing to the second data platform.

9. The method of claim 8, wherein the synchronizing the migrated bulk data comprises:
synchronizing the migrated bulk data in the second data platform with the bulk data in the first data platform for a predetermined period of time; and
automatic retrieval of failures from a previous cycle.

10. The method of claim 9, wherein the fetching the storage records for the bulk data and the migrating the bulk data from the first data platform to the second data platform are performed in parallel.

11. A system for migrating bulk data from a first data platform to a second data platform, comprising:
the first data platform;
the second data platform;
one or more processors; and
at least one memory comprising at least one non-transitory computer-readable medium storing instructions that, when executed by at least one of the one or more processors, cause the system to perform operations, the operations comprising:
providing a virtual machine (VM) on a cloud service provider subscription;
migrating access control list (ACL) information, one or more legal tags, and reference data from the first data platform to the second data platform, using the VM to control the migrating;
analyzing data types of the bulk data;
generating a file-generic data migration pipeline from the first data platform to the second data platform, the file-generic data migration pipeline using the VM;
fetching storage records for the bulk data from the first data platform using the VM;
migrating the bulk data from the first data platform to the second data platform, using the VM to control the migrating;
validating the migrated bulk data in the second data platform; and
synchronizing the migrated bulk data in the second data platform with any changes made to the bulk data in the first data platform since the migrating the bulk data began.

12. The system of claim 11, wherein the migrating the access control list (ACL) information, one or more legal tags, and reference data from the first data platform to the second data platform comprises:
determining access to available ACL groups in the first data platform;
creating new ACL groups in the second data platform;
determining whether the one or more legal tags are different between the first data platform and the second data platform;
in response to the one or more legal tags being determined to be different, mapping a change in the one or more legal tags determined to be different between the first data platform and the second data platform tags;
adding the one or more legal tags to the second data platform;
determining whether reference data is added or modified between the first data platform and the second data platform; and
generating a query for determining which reference data is added or modified between the first data platform and the second data platform.

13. The system of claim 12, wherein the analyzing data types of the bulk data comprises:
generating a hierarchical data model of the data types to determine an order of ingestion of the bulk data; and
determining a scope of ancestry migration based on the hierarchical data model.

14. The system of claim 13, wherein the generating the file-generic data migration pipeline comprises:
downloading files for a given set of record identifications (IDs) of the first data platform and ingesting the files into the second data platform;
during the downloading and ingesting of the files, populating a migration database with ID mapping information about the record IDs and version information from the first data platform and the second data platform; and
using the ID mapping information during migration of records from a storage service associated with the first data platform.

15. The system of claim 14, wherein the fetching the storage records for the bulk data comprises:
generating one or more schema for custom data types from the first data platform to the second data platform;
running the file-generic data migration pipeline to migrate sample records corresponding to the custom one or more schema for the custom data types;
determining an order of ingestion for the data types based on the hierarchical data model;
selecting one data type at a time for ingestion;
fetching the record IDs and iterating a list of sample Work Product Component (WPC) record IDs for the records from the storage service;
transforming the records from a first data format compatible with the first data platform to a second data format compatible with the second data platform using the ACL groups, any changed legal tags, and record IDs; and
ingesting the records.

16. The system of claim 15, wherein the transforming the records comprises:
changing each ACL based on a new tenant ID for each ACL;
changing any of the one or more legal tags determined to be different;
in response to a record ID including a version ID, removing the version ID from the record ID including the version ID;
retaining ancestry records based on the determined scope of the ancestry migration; and
providing a version ID for the ancestry records.

17. The system of claim 16, wherein the migrating the bulk data from the first data platform to the second data platform comprises:
iterating the list of sample WPC record IDs to fetch the bulk data associated with the list;
ingesting the bulk data into the second data platform in an order based on the list;
determining whether match and merge rules are used for a Well Known Entity (WKE) generation service in the first data platform;
in response to determining that match and merge rules are used for the WKE generation service in the first data platform, checking and migrating the bulk data; and
analyzing mapping of Well-Known Schemas (WKS) associated with the bulk data.

18. The system of claim 17, wherein the validating the migrated bulk data in the second data platform comprises:
implementing search service application programming interfaces (APIs) to fetch record counts of all data types in both the first data platform and the second data platform;
comparing the record counts of all data types in the first data platform to the record counts of all data types in the second data platform;
comparing an attribute count, a name, and a value for a selected record in both the first data platform and the second data platform; and
providing a visual validation of randomly selected migrated data in an application project pointing to the second data platform.

19. The system of claim 18, wherein the synchronizing the migrated bulk data comprises synchronizing the migrated bulk data in the second data platform with the bulk data in the first data platform for a predetermined period of time.

20. The system of claim 19, wherein the fetching the storage records for the bulk data and the migrating the bulk data from the first data platform to the second data platform are performed in parallel.
